(19) United States
(12) Patent Application Publication
(10) Pub. No.: US 2007/0130811 A1
(43) Pub. Date: Jun. 14, 2007

(54) Tamper evident label

(75) Inventors: Nicholas Shevelev, Nashville, TN (US); Gregory A. Pace, Nunnelly, TN (US)

Correspondence Address: FITCH EVEN TABIN AND FLANNERY, 120 SOUTH LA SALLE STREET, SUITE 1600, CHICAGO, IL, 60603-3406, US

(73) Assignee: U.S. Smokeless Tobacco Company

(21) Appl. No.: 11/298,039

(22) Filed: Dec. 9, 2005

(51) Int. Cl. G09F 3/00; G09F 3/10

(52) U.S. Cl. 40/312; 40/638

(57) ABSTRACT

A packaging label is provided having a base film, an ink layer, and an adhesive layer for adhering to a container. The label includes an indication marking for providing evidence of label tampering, which is preferably visible upon removal of the packaging label from a container. The label further includes an area of weakness on the base film extending the length of the film. The packaging label is severable along the area of weakness to divide the packaging label into first and second portions so that a lid may be removed from a container body.

### FIELD OF THE INVENTION

Packaging labels, and in particular, tamper-evident labels and containers for smokeless tobacco having the labels thereon.

### BACKGROUND OF THE INVENTION

Product containers, such as a typical smokeless tobacco container, are often sealed with a paper label adhered to both a lid and to a container body to seal the container while on the store shelf. The paper label secures the lid to the body, but also provides ease of lid opening after customer purchase. The paper label is easily delaminated, torn, or scored along an interface between the lid and container body to allow the container to be opened. However, current paper labels generally do not provide a sufficient indication to the purchasing customer that the label and lid may have been removed and replaced back onto the container. Therefore, even with a label affixed over the lid and body of a container, the consumer does not know if the internal contents of the container have been tampered with prior to purchase.

A tamper-evident label or security tape is a commonly used label that provides an indication that the label may have been removed. In one form, the security tape is an adhesive label that can be applied to a substrate that provides visible evidence of the label's removal. For instance, upon the security tape being removed, the tape leaves behind a residue on the substrate as evidence of its removal. Often the residue forms a text message, such as VOID or OPENED, or may form a repeated pattern, such as a checkerboard pattern. Once removed, even if the security tape is re-applied to the substrate, the patterned residue or textual message makes it difficult to re-align the removed portion back on the substrate to appear as if the label was never removed. Accordingly, even if re-applied, the security tape typically provides evidence of its prior removal.

Such security labels are often used to provide evidence of unwanted tampering of a container or its contents. For instance, if the tape's security features are visible, then evidence exists that, at a minimum, the label has been removed. Upon evidence that the label has been removed, then it is also possible that the internal contents of the container have been tampered with. On the other hand, an intact security label generally presents evidence of non-tampering, which may indicate that the container or internal contents are in their original condition.

While the security tape does provide adequate evidence of its unwanted removal, by the very nature of the security tape itself, it is difficult for the removal of the security label from the container when desired so that the container may be opened and its contents used. Generally, once the non-tampered container has been purchased by a consumer, then the security function of the label is no longer needed as the consumer is already satisfied that the container has not been tampered with. After purchase of the non-tampered container, the consumer desires a quick, easy, and clean method for breaking the seal of the security label so that the container may be opened.

Security tapes generally use polypropylene or similar plastic films with aggressive adhesives. Such tape characteristics make opening the container difficult. For example, the polymer films are difficult to cut, the aggressive adhesive may damage the container, and the security features often leave residue on the container or label. As a result, while the security tape provides assurances that the container most likely has not been tampered with, the security tape also renders opening the container difficult and often creates an unpleasing appearance on the container after being opened.

Accordingly, it is desired for a security tape or label that provides evidence of its undesired removal, but also permits desired removal or breaking of at least a portion of the label for ease of opening a container onto which the label is applied.

### SUMMARY OF THE INVENTION

The invention relates to a packaging label that provides evidence of label tampering. In one form, the label includes a base film, an adhesive layer on the base film for adhering to a container, and an ink layer. The label also preferably includes an indication marking or markings for providing evidence of label tampering that is visible upon removal of the label from a container or other substrate. In a preferred form, the label also has an area of weakness on the base film extending its length. The label is severable or breakable along this area of weakness to divide the label into first and second portions. In one form, the first label portion is generally adhered to a lid sidewall and a second label portion is generally adhered to a container body sidewall. In this manner, it is simple for the lid to be removed from the container body upon the label being severed along the area of weakness. The packaging label is preferably adhered to a smokeless tobacco container. However, the label may also be adhered to any container in which a purchasing consumer desires to open the container after being assured of its integrity prior to purchase.

In other aspects, the area of weakness includes a row of perforations. The label, as a result, is easily divided into the first and second portions by severing or breaking the perforations. In one embodiment, the area of weakness may also include a plurality of substantially parallel rows of perforations. The parallel rows of perforations aid in aligning the area of weakness along an interface between the lid and container. Alternatively, the area of weakness may also include a partial score, slit, or cut into the thickness of the film instead of the perforations. Similarly, the label may include a plurality of substantially parallel partial score lines.

In another embodiment, the packaging label may also include a tab portion extending outwardly from an edge thereof and a notch in an opposing label edge. The notch is preferably substantially aligned with the tab portion. In this embodiment, the label also includes a strip portion that extends between the tab portion and the notch. In such form, the tab is peelable away from the label along the strip to sever the label into the first and second portions.

The base film may also be formed from an oriented plastic. With such material, the label may also include a second area of weakness that also extends the length of the label. The two areas of weaknesses may define the strip portion therebetween. While not wishing to be limited by theory, it is believed that the areas of weakness can be formed from the oriented condition or characteristics of the plastic.

The invention also relates to a container that provides evidence of its undesired opening or tampering. In this form, the container includes a container body having a side wall and a container lid that forms an interface between a portion of the container lid and a portion of the container side wall. The container also includes a label similar to that described above, which is adhered to both the container side wall and the lid. It is preferred that the first label portion is generally adhered to the container body side wall and the second label portion is generally adhered to the lid so that upon lid removal each label portion remains adhered to such container section.

In another embodiment, the label has a release area on the base film and an ink layer on both the base film and on the release area. In general, the release area corresponds to the indication marking. In this aspect, the release area has a Surface Energy about 2 to about 3 Dyne/cm greater than a Surface Tension of the ink layer. In this manner, the ink layer may be coated or otherwise applied over the release area, but still be removable therefrom upon the removal of the label from the container. In another aspect, the base film has a Surface Energy at least about 10 Dyne/cm greater than a Surface Tension of the ink layer. In this manner, the ink layer adheres to the base film upon removal of the label from the container.

The indication marking may also include a residual indicator on the container and a revealed indicator on the base film. The residual indicator may include a portion of the adhesive layer and a portion of the ink layer each corresponding to the release area. The revealed indicator comprises a portion of the base film corresponding to the release area. The release area, the residual indicator, and the revealed indicator may each form a textual message.

### BRIEF DESCRIPTION OF THE DRAWINGS

FIG. 1 is a perspective view of an exemplary container having a security label thereon that embodies features of the present invention;

FIG. 1A is a perspective view of the container and security label of FIG. 1 illustrating the security label partially removed;

FIG. 2 is a perspective view of the container and security label of FIG. 1A illustrating details of the label;

FIG. 2A is a partial, plan view of the container and label of FIG. 2;

FIG. 3 is a perspective view of the container of FIG. 1 illustrating an alternative, exemplary security label thereon embodying features of the present invention;

FIG. 3A is a perspective view of the container of FIG. 3 illustrating a lid removed from a container body with the security label partially removed;

FIG. 4 is a perspective view of the container of FIG. 1 illustrating an alternative, exemplary security label thereon embodying features of the present invention;

FIG. 4A is a perspective view of the container and security label of FIG. 4 illustrating a portion of the security label being removed from the container;

FIG. 4B is a perspective view of the container of FIG. 4 illustrating an alternative, exemplary security label thereon embodying features of the present invention; and

FIG. 4C is a perspective view of the container and security label of FIG. 4 illustrating a lid removed from a container body with the security label partially removed.

### DESCRIPTION OF THE PREFERRED EMBODIMENTS

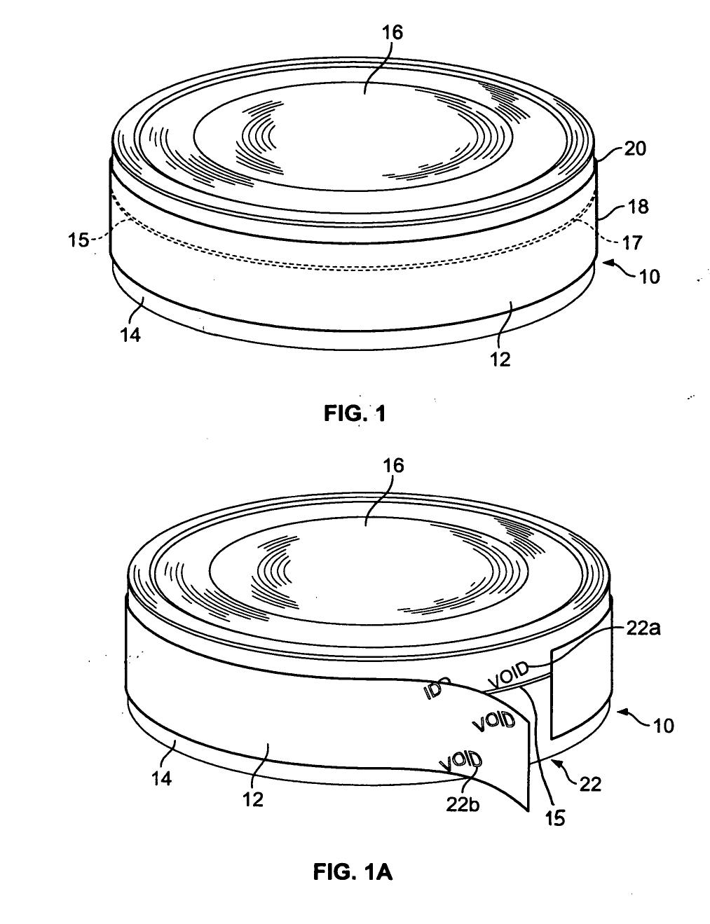

Referring to FIG. 1, an exemplary container 10 having a label 12 thereon is illustrated that embodies features of the present invention. In one form, the container 10 may be a typical smokeless tobacco container having a container body 14 and a lid 16; however, the container 10 may be any container in which a purchasing consumer desires to open the container after being assured of its integrity prior to purchase. Formed on the container 10, when the lid 16 is received on, over, or in the container body 14, is an interface 15 between an edge 17 or other portion of the lid 16 and a portion of the container body 14. As shown in the illustrated embodiment, the label 12 is preferably applied to both the container body 14 and the lid 16 over a portion of the interface 15. In this manner, the label 12, while providing information to the purchasing consumer, also seals or secures the lid 16 to the container body 14. In other words, as shown in the embodiment of FIG. 1, the label 12 is preferably applied to a side wall 18 of the container body 14 and to a side wall 20 of the container lid 16 over a portion of the interface 15. As shown, the label 12 encircles the entire container 10 on the side walls 18 and 20; however, the label 12 may also extend only partially around the container. Alternatively, the label 12 may be applied to the container 10 transversely around a top and bottom rather than circumferentially around the sides.

As illustrated in FIG. 1A, the label 12 is shown as a tamper-evident label or a security tape that provides evidence 22 of its unwanted or undesired removal. For example, the evidence 22 of the unwanted removal may be a residual indicator 22a on the container 10 and/or a revealed indicator 22b on the label 12. While the residual indicator 22a and the revealed indicator 22b are illustrated as a textual “VOID” message, such tamper evidence 22 may be other text messages, patterns, images, or the like on the label 12 and/or the container 10. Accordingly, the container 10 having the security label 12 thereon provides evidence whether or not the container has been tampered with. If the evidence 22 is visible, then the consumer is alerted to a possible tampering of the container 10. Conversely, if the evidence 22 is not visible, then the consumer is notified that the container most likely has not been tampered with. In that regard, as illustrated in FIGS. 1 and 1A, if the label remains applied to the container 10, then the evidence 22 is not visible (FIG. 1). On the other hand, as will be further discussed below, if the label is removed or partially removed, then the evidence 22 becomes visible (FIG. 1A).

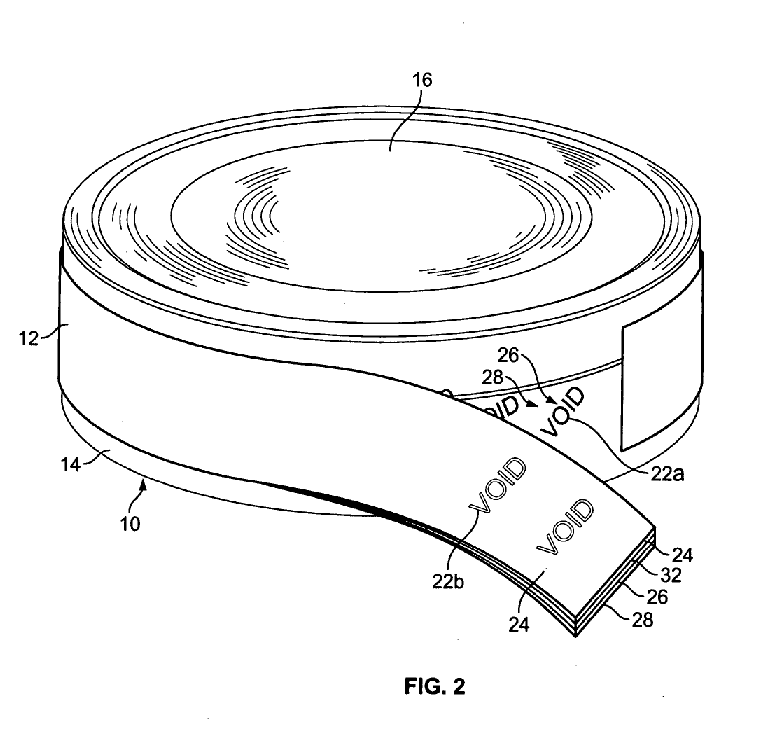

Referring to FIGS. 2 and 2A, the label 12 is preferably formed from a multi-layer construction. In the illustrated embodiment, the label 12 includes a base film 24 having an ink layer 26 and an adhesive layer 28 thereon. That is, the ink layer 26 is preferably on the film 24 and the adhesive layer 28 is on the ink layer 26. The film 24 may be clear or colored transparent plastic films, such as polyester, polypropylene, polycarbonate, or similar plastic films. It is preferred that the films have a thickness of about 0.5 to 5 mils thick. The ink layer 26 may include colored inks, UV-cured inks, solvent-based inks, or water-based inks. The inks may be applied to the label 12 through flood coating, gravure coating, Meyer rod coating, flexographic processes, lithographic coating methods, or other suitable coating methods. The adhesive layer may include pressure sensitive adhesives, UV-cured adhesives, solvent-based adhesives, or water-based adhesives. The adhesive may also be applied through gravure coating, Meyer rod coating, flexographic, lithographic coating methods, or other suitable coating methods.

More specifically, the ink layer 26 is applied onto an inner surface 30 of the film 24 and the adhesive layer 28 is then applied onto the ink layer 26. In other words, the ink layer 26 is preferably between the film 24 and the adhesive layer 28. In addition, spaced throughout the label 12 are at least one, and preferably a plurality, of low adhesion or release areas 32 between the film surface 30 and the ink layer 26. In one form, the areas 32 are recesses in the ink layer 26 so that a space is formed between the ink layer 26 and the film surface 30. In other forms, the areas 32 may be a release agent or other coating applied to the film 24.

Preferably, the release areas 32 are a clear release coating that is initially applied as a particular pattern (i.e. “VOID” text, etc.) to the surface 30 of the film 24 prior to the ink layer 26. The clear coating of the area 32, when dried, has a Surface Energy high enough to be wet and coated by the ink layer 26, but also low enough to provide a weak adhesion between the ink layer 26 and film 24. As discussed below, the adhesion in the areas 32 between the ink layer 26 and film 24 is less than the adhesion between the adhesive layer 28 and the container 10.

The label 12 is applied to the container 10 by pressing the adhesive layer 28 to the container 10 by a predetermined amount of force so that the adhesive layer 28 adheres to both the container lid 16 and the container body 14 as previously described. If the label 12 is then removed, such as by the undesired peeling back of the label 12 from the container 10, the label 12 will partially or completely destroy itself. That is, the label 12 will separate or delaminate into a plurality of layers, some of which remain on the container 10 and others which remain with the peeled back label 12. For example, upon undesired label removal, the label 12 will separate portions of the ink layer 26 and portions of the adhesive layer 28 from the film 24 that correspond to the areas 32 to provide the evidence 22 of its unwanted removal. Preferably, such separation forms the residual indicator 22a on the container 10 and the revealed indicator 22b on the label 12. The areas 32 between the ink layer 26 and the film 24 allow the separation or delamination therebetween so that the residual indicator 22a remains on the container 10 and the revealed indicator 22b remains on the label 12 for any portion of the label 12 that corresponds to the areas 32.

The residual indicator 22a preferably includes a residual ink layer 26a and a residual adhesive layer 28a that remain adhered to the container 10. In one form, the residual indicator 22a is a strip of the residual ink layer 26a and the residual adhesive layer 28a having a textual message or pattern thereon, such as “VOID” or “OPENED”. In such form, the strip generally has a predetermined length and width corresponding to the area 32. In other forms, the residual indicator 22a forms the textual message itself rather than being a strip having the message thereon. In such alternative form, the residual indicator 22a includes the residual ink layer 26a and the residual adhesive layer 28a in the shape of the letters or patterns making up the textual message or pattern. That is, the area 32 is in the shape of the desired evidence 22. If the label has a plurality of areas 32, then upon unwanted removal of the label 12, a plurality of residual indicators 22a will be on the container 10 corresponding to the areas 32.

The revealed indicator 22b, on the other hand, includes a portion 24a of the base film 24 that also corresponds to the area 32. That is, the revealed indicator 22b is the portion of the label 12 that remains after the residual ink layer 26a and the residual adhesive layer 28a have been removed therefrom upon the unwanted peeling of the label 12. Within the portion 24a may be a printed, translucent, or transparent textual message that corresponds to the textual message in the residual indicator 22a. Alternatively, the revealed indicator 22b may be a void space in the ink and adhesive layers remaining on the label 12 that corresponding to the area 32. That is, as described above, the area 32 may form the textual message or other pattern itself by the application of the clear release layer in the shape of the textual message on the film surface 30. As a result, upon unwanted peeling of the label 12, the area 32 form the revealed indicator 22b from the base film 24 and defined by or surrounded by the ink layer 26 and adhesive layer 28 still remaining on the film 24. In other words, the revealed indicator 22b is a clear, translucent, or transparent indication or message through the label 12 that corresponds to the area 32 in the shape of the desired evidence 22.

To form such security tape 12, the levels of adhesion between the film 24, the ink layer 26, and the adhesive layer 28 may vary compared to the level of adhesion between the adhesive layer 28 and the container 10. The differential adhesions between the various layers may be selected such that, upon unwanted removal of the label 12 as previously described, the residual adhesive layer 28a remains on the container 10 and a second portion 28b of the adhesive layer 28 remains on the removed label 12. Therefore, in such areas where the adhesive layer 28b is removed from the container 10, the level of adhesion between the ink layer 26, the adhesive layer 28b, and the film 24 must be greater than the level of adhesion between the adhesive layer 28b and the container 10. Similarly, in the residual indicator 22a, the level of adhesion between the residual ink layer 26a and the area 32 (i.e. “VOID”) must be less than the level of adhesion between the residual adhesive layer 28a, the ink layer 26, and the container 10. As discussed above, the lower level of adhesion between the residual ink layer 26a and the film 24 may be from the area 32 having a release coating, a release agent, a void space, or the like therein.

In one embodiment, it has been discovered that a Surface Energy of the film surface 30 should be at least 10 Dyne per centimeter greater than a Surface Tension of the liquid ink or ink layer 26. Such difference provides good adhesion of the dry ink layer 26 to the film 24. On the other hand, a Surface Energy of the area 32 (i.e., “VOID”) should be only 2-3 Dyne per centimeter greater than the Surface Tension of the liquid ink or ink layer 26. This lower difference is generally sufficient to provide a positive wetting of the area 32 by the ink, but also provides release of the ink layer 26 from the base film 24 corresponding to the area 32 upon removal of the label 12. Therefore, upon label 12 removal, the ink layer 26 and adhesive layer 28 that corresponds to the area 32 delaminate from the film 24 and remain on the container 10 as the residual ink layer 26a and the residual adhesive layer 28a. The void left by the removed ink layer and removed adhesive layer form the revealed indicator on the film 24 as described above.

The container 10 having the label 12 thereon can be opened in several ways. For example, the lid 16 can be twisted relative to the container body 14 (or vise versa) in order to break the label 12 circumferentially along the container interface 15. Alternatively, a thin object, such as a utensil, key, knife, fingernail, or the like can score or sever the label 12 approximate the interface 15 and cut the label 12 around the container 10. In addition, the label 12 may still be peeled or removed from the container 10.

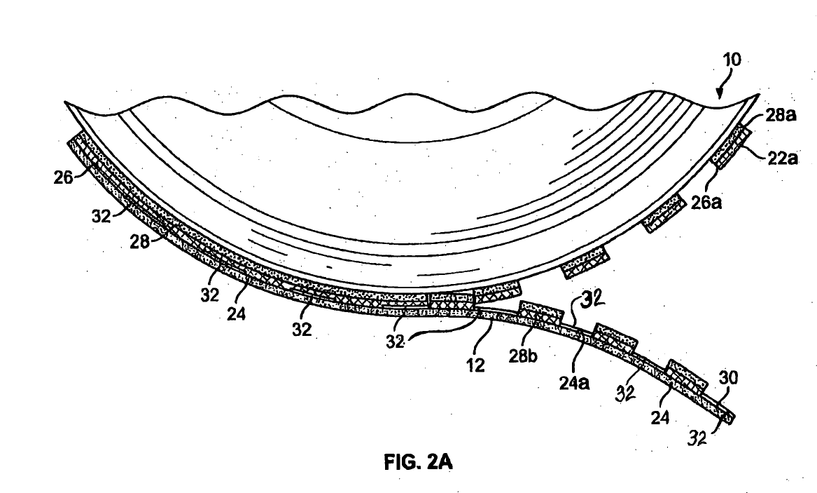

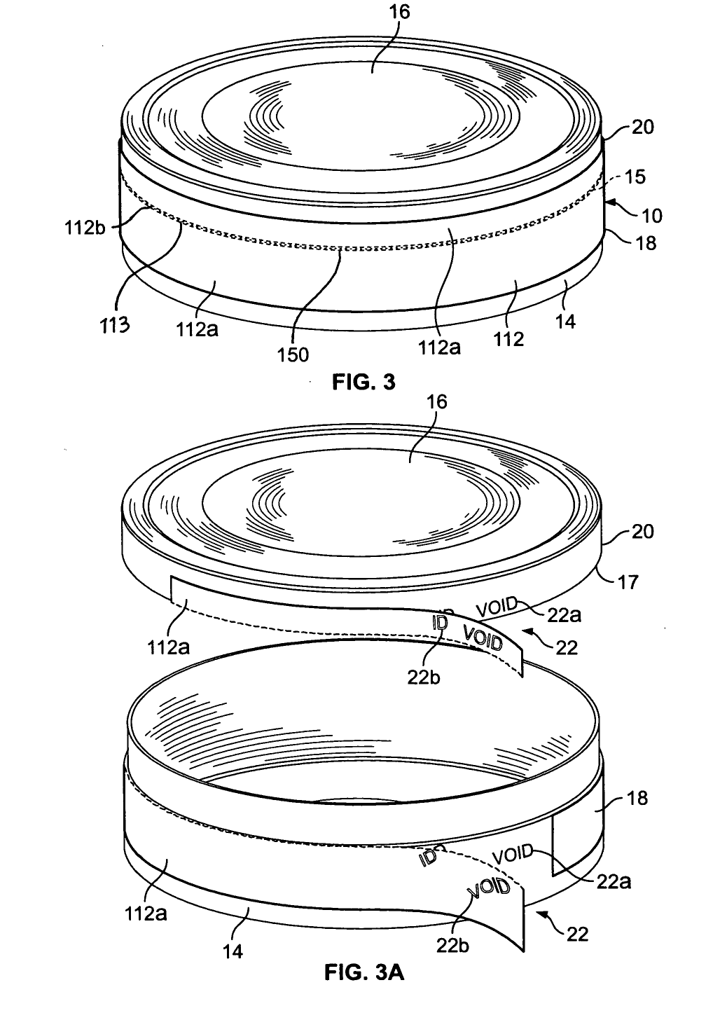

Referring to FIGS. 3 and 3A, an alternative label 112 embodying features of the invention is also illustrated on the container 10. The label 112 is also a tamper-evident label or security tape similar to label 12, but further includes an area of weakness 113 to provide desired opening of the container 10. As shown, the label 112 generally includes a pair of tamper-evident portions 112a with the area of weakness 113 therebetween. In addition, as shown in FIGS. 3 and 3A, one of the tamper-evident portions 112a is generally adhered to the container sidewall 18 and the other tamper-evident portion 112a is generally adhered to the lid side wall 20. In that regard, the tamper-evident portion 112a adhered to the lid sidewall 20 is generally narrower than the tamper-evident portion 112a adhered to the container sidewall 18. Preferably, the areas of weakness 113 is aligned with the container interface 15 so that when the area of weakness 113 is deformed or broken, as described below, the lid 16 and container body 14 are separated.

More specifically, the tamper-evident portions 112a of the label 112 are similar to the previously described label 12 and, as illustrated in FIG. 3A, form the residual indicator 22a and the revealed indicator 22b upon the unwanted removal of the entire label 112 or upon the unwanted removal of either section 112a by itself. As will be further described below, the label 112 is deformable, such as being breakable, along the area of weakness 113 so that the tamper-evident portions 112a can be separated to form distinct labels. Preferably, upon such deformation of the label 112 along the area of weakness 113, one tamper evident portion 112a is generally adhered to the lid side wall 20 and the other tamper-evident portion 112a is generally adhered to the container body side wall 18 so that the lid 16 may be removed from the container body 14.

The area of weakness 113 facilitates the desired opening of the container 10 by allowing the label 112 to be more easily deformed (i.e., broken) than the label 12. In one embodiment, the area of weakness 113 includes perforations 150 along the length of the label 112. The perforations 150 are a plurality of small slits having portions of the label 112 therebetween that extend the length of the label 112 in at least one row, and preferably, a plurality of parallel rows that are aligned with the container interface 15. In a preferred embodiment, the area of weakness 113 includes at least three parallel rows of perforations 150 so that it is easier to align or register the areas of weakness 113 along the container interface 15. The perforations 150 may include slits or other small openings that extend through the adhesive layer 28, the ink layer 26, and the film 24. The perforations 150 preferably include alternating slits and the portion of the label 112 therebetween.

When the label 112 is applied to the container 10, the perforations 150 are preferably aligned or superimposed with the interface 15 between the container lid 16 and the container body side wall 18 to facilitate ease of lid removal. For example, with the perforations 150 in such orientation, the purchasing consumer may twist the lid 16 relative to the container body 18 to break the perforations 150 in order to open the container 10. Alternatively, the purchasing consumer may break the perforations 150 using a tool, such as knife, key, utensil, fingernail, or other thin object. Once the area of weakness 113 of the label 112 is deformed along the perforations 150, the tamper-evident portions 112a become the separate labels on the lid 16 and container body 18 as described above and shown in FIG. 3A.

Alternatively, the area of weakness 113 may be a laser-slit or laser-scored recess in the label 112. For example, the laser-slit recess may be a cut or score that extends about half the thickness of the film 24 so that when the consumer twists the lid 16 relative to the container body 14, the thinner film material corresponding to the recess easily breaks. As with the perforations 150, the area of weakness 113 may also be a plurality of parallel laser-slit recesses that extend the length of the label 112. Alternatively, the thinner laser-cut recesses also allow the tool described above to easily cut or pierce the label 112. As with the perforation 150, the laser-slit recess are preferably aligned or superimposed with the interface 15 when the label 112 is applied to the container 10 to facilitate ease of container 10 opening.

Optionally, the area of weakness 113 of the label 112 may also correspond to a non-tamper evident portion 112b. The non-tamper evident portion 112b does not form the residual indicator 22a or the revealed indicator 22b upon its removal, cutting, tearing, breaking, or other deformation. For example, the non-tamper-evident portion 112b does not include any areas 32 between the ink layer 26 and film 24. As a result, upon the deformation of portion 112b along the area of weakness 113, the evidence 22 is not formed and the label 12 may be separated into two distinct security portions 112a as previously described. In this manner, the tamper evidence 22 is only revealed upon undesired removal of the label 112 or label portions 112a and not through the desired deformation of the area of weakness 113.

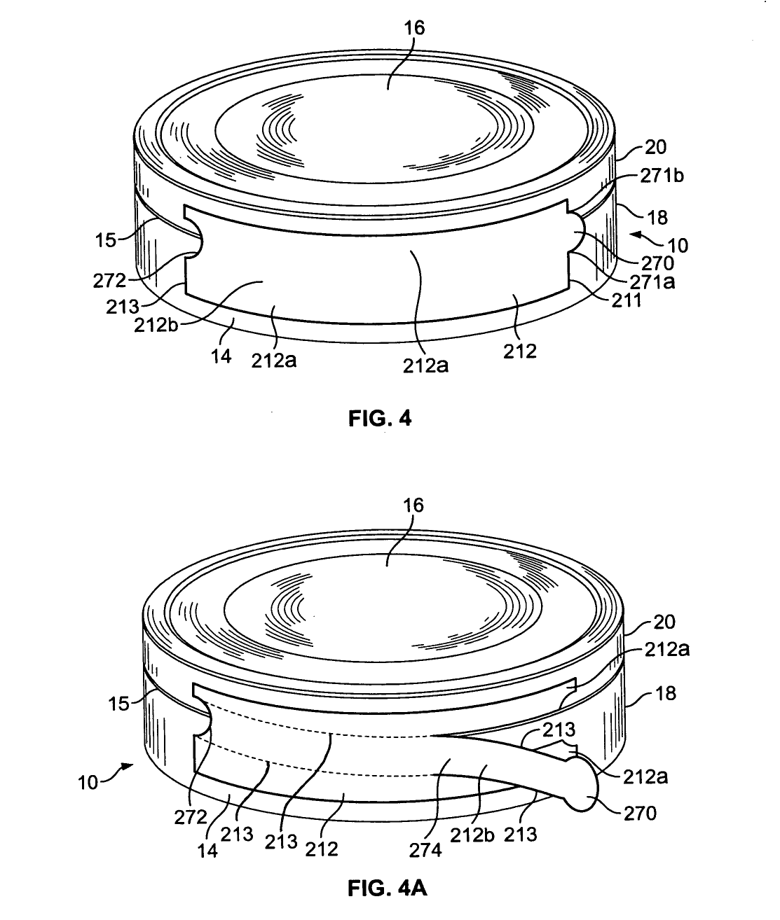

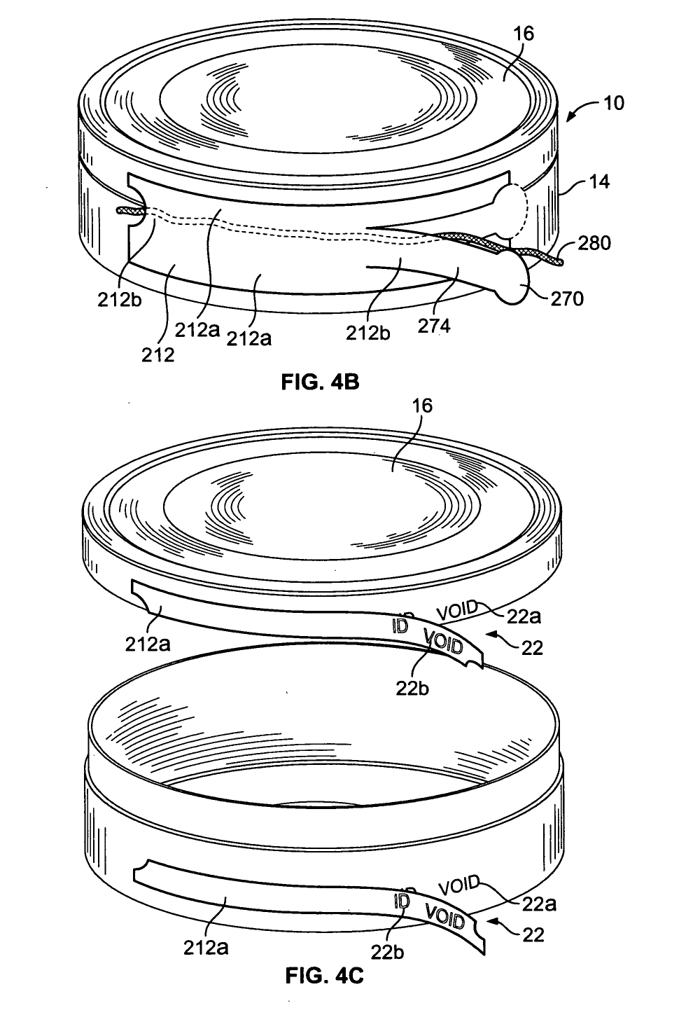

Referring to FIGS. 4 and 4A-4C, another alternative label 212 embodying features of the invention is also illustrated on the container 10. Similar to the labels 12 and 112, the label 212 is also a tamper-evident label or security tape. As shown, the label 212 is formed form an oriented film so that the label 212 may be easily separated into multiple portions. For instance, upon desired deformation, the label 212 separates into a pair of peripheral tamper-evident portions 212a and a central tamper-evident portion 212b therebetween that is generally aligned with container interface 15.

As shown in FIG. 4C, the label 212 also forms the residual indicator 22a and revealed indicator 22b upon the entire label 212 being removed from the container 10 or upon the tamper-evident portions 212a or 212b being removed from the container 10. The label 212 also preferably includes at least two areas of weakness 213 that are generally aligned with or preferably define lengthwise the tamper-evident portion 212b. Similar to the label 112, the areas of weakness 213 facilitate the desired opening of the container 10. As will be described in more detail below, the areas of weakness 113 are generally the result of the label 212 being formed from an oriented film that facilitates the tearing in the longitudinal direction.

In this embodiment, the label 212 also includes a tab 270 on one edge thereof, such as edge 211, and a corresponding notch 272 on an opposing edge thereof, such as opposing edge 213. It is preferred that the labels are formed from a strip of the oriented film so that the notch 272 corresponds to a tab 270 on an adjacent label 212 on the strip. In this regard, there is no wasted film during manufacture of the labels. As best illustrated in FIG. 4A, the tab 270 and notch 272 are also generally aligned with the tamper-evident portion 212b as well as the container interface 15 when the label 212 is applied to the container 10. While the tab 270 is illustrated as a semi-circular extension from the label side 211, the tab 270 may be any appropriate extension or protrusion of the label 212 at an end thereof. Likewise, the notch is illustrated as a semi-circular recess in the opposite side of the label; however, the notch 272 may also be any recess, indentation, or other groove in the opposing edge 213 that is substantially the same width as the notch 270.

More specifically, the tab 270 is preferably a semi-dcircular projection that forms a predetermined angle with the edge 211 at an intersection 271a and 271b between opposing edges of the tab 270 and the label edge 211. Preferably, the predetermined angle is about 90° or less. As will be further described below, the predetermined angle helps the tab 270 facilitate the deformation or removal of the tamper-evident portion 212b along the areas of weakness 213. Removal of the tamper-evident portion 212b also generally forms a strip 274 between the areas of weaknesses 213 that extends between the tab 270 and notch 272. In that regard, each of the intersections 271a and 271b are substantially aligned with one of the areas of weakness 213.

In this embodiment, the label 212 is preferably formed from an oriented film 24. That is, film 24 is a polymer film that is oriented in only one direction, such as an oriented polypropylene. In such form, as shown in FIG. 4A, the oriented polymer film allows the intersections 271a and 271b to cut or slice the film 24 lengthwise generally along each of the areas of weakness 213 when the notch 270 is peeled outwardly and away from the container 10. In that regard, as the notch 270 is peeled away from the container 10, the oriented film 24 allows the strip 274 to be cut and removed from the label 212 lengthwise to expose the container interface 15. While not wishing to be limited by theory, the orientation of the film 24 in a single direction facilitates the tearing of the film along the areas of weakness 113 because of the fibers of the film are oriented only in a single direction, which is generally lengthwise down the label 212. That is, the areas of weakness 213 may not be specific weaknesses or areas in the film 24, but generally result from the oriented nature or characteristic of the film and the intersections 217a and 271b of the notch 270.

The removal of the strip 274 also generally divides the label 212 into two separate portions, which generally correspond to the two tamper-evident portions 212a. For example, after removal of the strip 274, one of the tamper-evident portions 212a is generally adhered to the container body 18 and the other tamper-evident portion 212a is generally adhered to the container lid 14.

As illustrated in FIG. 4B, the label 212 may also include an optional tear string 280 embedded within the label 212 or captured between the label 212 and the container 10 surface upon which the label is applied. Preferably, the tear string 280 is aligned with the tamper-evident portion 212b and spaced between the two areas of weakness 213 along the container interface 15. As a result, the string 280 helps deform or tear the tamper-evident portion 212b from the label 212 and form the strip 274 as previously described.

After the strip 274 has been removed from the label 212, as illustrated in FIG. 4C, the label 212 is divided into two separate label portions, which generally correspond with the tamper-evident portions 212a. As previously described, one of the tamper-evident portions 212a remains on the container lid 16 and the other tamper-evident portion 212a remains on the container body 14. With the interface 15 being exposed, the lid 16 is easily removed from the body 14 to open the container. On the other hand, even when closed, the now divided label 212 still presents a pleasing appearance to the consumer rather than a destroyed or torn label showing the evidence 22. However, if either of the tamper-evident portions 212a are further removed, they will also provide the visible evidence 22 of removal as shown in FIG. 4C and as previously described. As a result, the label 112 also provides assurances to a purchasing consumer of the container's integrity prior to purchase, but provides for ease of opening after purchase when such integrity assurances are generally no longer needed.

In an alternative embodiment, the tamper-evident portion 212b may be modified so that it does not form the evidence 22 upon being deformed or removed from the container. That is, the modified-tamper-evident portion 212b would not form the residual indicator 22a or the revealed indicator 22b upon its removal from the container 10 as describe above. Moreover, the deformation of the modified-tamper-evident portion 212b would also not cause either of the tamper-evident portions 212a to show the evidence 22. For example, the modified-tamper-evident portion 212b would not include the areas 32 between the ink layer 26 and film 24. In such configuration, therefore, the entire modified-tamper-evident portion 212b would have a level of adhesion between the ink layer 26 and the film 24 preferably greater than the level of adhesion between the adhesive layer 28 and the container 10. Therefore, upon removal of the strip 274, the modified-tamper-evident portion 212b would not leave the evidence 22 of it removal.

It will be understood that various changes in the details, materials, and arrangements of parts, components, and method steps which have been herein described and claimed in order to explain the nature of the invention may be made by those skilled in the art within the principle and scope of the invention as expressed in the appended claims.

What is claimed is:

1. A packaging label comprising:
a base film having a length and a width;
an adhesive layer on the base film for adhering to a container;
an indication marking for providing evidence of label tampering, the indication marking visible upon removal of the packaging label from a container; and
an area of weakness on the base film extending the length of the base film, the packaging label severable along the area of weakness to divide the packaging label into first and second portions.

2. The packaging label of claim 1, wherein the packaging label is adhered to a smokeless tobacco container, the first label portion adhered to a lid sidewall and the second label portion adhered to a container body sidewall.

3. The packaging label of claim 1, wherein the area of weakness comprises perforations, the perforations being severable to divide the packaging label into the first and second portions.

4. The packaging label of claim 3, wherein the area of weakness comprises a plurality of substantially parallel rows of perforations.

5. The packaging label of claim 1, wherein the base film has a thickness and the area of weakness comprises a partial score into the thickness of the film.

6. The packaging label of claim 5, wherein the area of weakness comprises a plurality of substantially parallel partial score lines.

7. The packaging label of claim 1, wherein the label further comprises a tab portion extending outwardly from an edge thereof; a notch in an opposing label edge, the notch being substantially aligned with the tab portion; and a strip portion of the label extending between the tab portion and the notch, the tab peelable away from the label along the strip to sever the label into the first and second portions.

8. The packaging label of claim 7, wherein the base film comprises an oriented plastic; and the label further comprises a second area of weakness extending the length of the label, the areas of weaknesses generally defining the strip portion therebetween; and the areas of weakness formed from the oriented plastic.

9. A container providing evidence of undesired opening, the container comprising:
a container body having a side wall;
a container lid forming an interface between a portion of the container lid and a portion of the container side wall;
a label adhered to both the container side wall and the lid, the label comprising:
a base film having a length and a width;
an adhesive layer on the base film for adhering to the container;
an indication marking for providing evidence of label tampering, the indication marking visible upon removal of the label from the container; and
an area of weakness on the base film extending the length of the base film, the area of weakness generally aligned with the container interface;
the packaging label severable along the area of weakness to divide the packaging label into first and second portions; and
the first label portion adhered to the container body side wall and the second label portion adhered to the lid.

10. The container of claim 9, wherein the label has a release area on the base film; an ink layer on both the base film and on the release area; and the release area corresponding to the indication marking.

11. The container of claim 10, wherein the release area has a Surface Energy about 2 to about 3 Dyne/cm greater than a Surface Tension of the ink layer such that the ink layer may be applied over the release area and removable therefrom upon the removal of the label from the container.

12. The container of claim 11, wherein the base film has a Surface Energy at least about 10 Dyne/cm greater than a Surface Tension of the ink layer such that the ink layer adheres to the base film upon removal of the label from the container.

13. The container of claim 10, wherein the indication marking comprises a residual indicator on the container and a revealed indicator on the base film.

14. The container of claim 13, wherein the residual indicator comprises a portion of the adhesive layer and a portion of the ink layer corresponding to the release area.

15. The container of claim 13, wherein the revealed indicator comprises a portion of the base film corresponding to the release area.

16. The container of claim 13, wherein the release area, the residual indicator, and the revealed indicator each form a textual message.

17. A method of opening a container having a security label thereon, the method comprising:
providing a container having a container body with a side wall; a container lid forming an interface between a portion of the container lid and a portion of the container side wall; the security label adhered to both the container side wall and the lid, the security label comprising a base film having a length and a width; an adhesive layer on the base film for adhering to the container; an indication marking for providing evidence of label tampering, the indication marking visible upon removal of the label from the container; and an area of weakness on the base film extending the length of the base film, the area of weakness generally aligned with the container interface; the label including first and second portions; and the first label portion generally adhered to the container body side wall and the second label portion generally adhered to the lid;
breaking the area of weakness such that the label is divided into two portions substantially corresponding to the first and second label portions; and
removing the lid from the body with the first label portion adhered to the container body side wall and the second label portion adhered to the lid.

18. The method of claim 17, wherein the area of weakness is broken by twisting the container lid relative to the container body.

19. The method of claim 17, wherein area of weakness is broken by peeling a strip of the label the length of the label.

20. The method of claim 17, wherein the area of weakness is broken by scoring the area of weakness.
